(19) United States
(12) Patent Application Publication
(10) Pub. No.: US 2009/0036286 A1
(43) Pub. Date: Feb. 5, 2009

(54) APPARATUS FOR MANUFACTURING A CIRCULAR BAG

(75) Inventors: Jurgen Beinghaus, Wipperfurth (DE); Peter Tommek, Kurten (DE); Albert Schmitz, Kurten-Sulze (DE)

Correspondence Address: PAUL, HASTINGS, JANOFSKY & WALKER LLP, 875 15th Street, NW, Washington, DC, 20005, US

(73) Assignee: LAUDENBERG VERPACKUNGSMASCHINEN GMBH, Wipperfurth (DE)

(21) Appl. No.: 12/181,040

(22) Filed: Jul. 28, 2008

(30) Foreign Application Priority Data
Jul. 30, 2007 (DE) 202007010662.9

(51) Int. Cl. B31C 1/00; B65B 51/10

(52) U.S. Cl. 493/269; 53/478

(57) ABSTRACT

An apparatus for manufacturing a circular bag is configured with two anvil half-sections that are movable relative to each other from an open position to a closed position. An ultrasonic sealing tool is provided that is movable towards and away from the anvil half-sections and configured to seal a lid portion to a sleeve portion of the circular bag. In the closed position, the anvil half-sections define an interior space which is at least as large as the exterior circumference of the circular bag to be manufactured.

### BACKGROUND

This application claims priority to German Patent Application No. 202007010662.9 filed on Jul. 30, 2007 which is incorporated herein by reference in its entirety.

### FIELD OF THE INVENTION

The present invention relates to an apparatus for manufacturing a circular bag in which the lid and/or the bottom of a circular bag can be ultrasound welded to a foil sleeve.

### BACKGROUND OF THE INVENTION

It is well-known that ultrasound welding shows advantages over thermal bonding, since the welded seal that is generated is clean even when the bag is filled with powdery materials and the powder gets close to the welded seam.

### BRIEF SUMMARY OF THE INVENTION

The present invention provides an apparatus for manufacturing a circular bag that permits easy and reliable ultrasound welding of the lid and/or bottom of the circular bag. In this connection, “circular bag” means that the bag, at least when filled, has a circular, elliptical or another round cross section whereby the shape of the cross section is determined by the shape of the lid and/or bottom.

In accordance with the invention, an apparatus for manufacturing a circular bag is fitted with two anvil half-sections which are movable relative to each other from an open position to a closed position. In the closed position, the anvil half-sections define an interior space that at least corresponds to the exterior circumference of the circular bag to be manufactured. Furthermore, the apparatus is fitted with an ultrasound sealing tool that is movable towards and away from the anvil half-sections.

Preferably, a centering device holds the anvil half-sections in a non-movable manner in the closed position. In this manner, the centering device can be fitted with at least one projection and a corresponding slot which are fitted onto or into the walls that are in contact with each other when the anvil half-sections are in the closed position.

It is preferable in the production sequence that the anvil half-sections are pivotable relative to each other although in other implementations the anvil half-sections are configured such that they can be pushed towards each other within one plane.

In one embodiment, one of the anvil half-sections is stationary and the other is movable. In this manner, the movable anvil half-section can be pivoted by means of a floating pivoting device on a rotational axis that is located in the border area of the anvil half-sections when in the closed position.

Preferably, the movable anvil half-section can be locked by a locking mechanism whereby a cross bar locks the movable anvil half-section in the closed position.

In an alternative implementation, the anvil half-sections are pivotable around a common axis. In this implementation, it is preferable that the anvil half-sections can be moved over a lever chain which reaches its dead point in the closed position.

In this manner, one of the anvil half-sections can be articulated with an eccentric adjuster that ensures a symmetrical position of the anvil half-sections to a foil sleeve that has to be welded.

Below, examples of embodiments of the invention will be described in further detail by means of the drawings.

### BRIEF DESCRIPTION OF THE DRAWINGS

In the following, the invention will be described in greater detail with reference to the attached figures.

FIG. 1 shows a first implementation of an apparatus for manufacturing a circular bag in the open position according to an embodiment of the present invention.

FIG. 2 shows the apparatus depicted in FIG. 1 in the closed position.

FIG. 3 shows a second implementation of an apparatus for manufacturing a circular bag in the open position according to an embodiment of the present invention.

FIG. 4 shows the apparatus in FIG. 3 in the closed position.

### DETAILED DESCRIPTION OF THE INVENTION

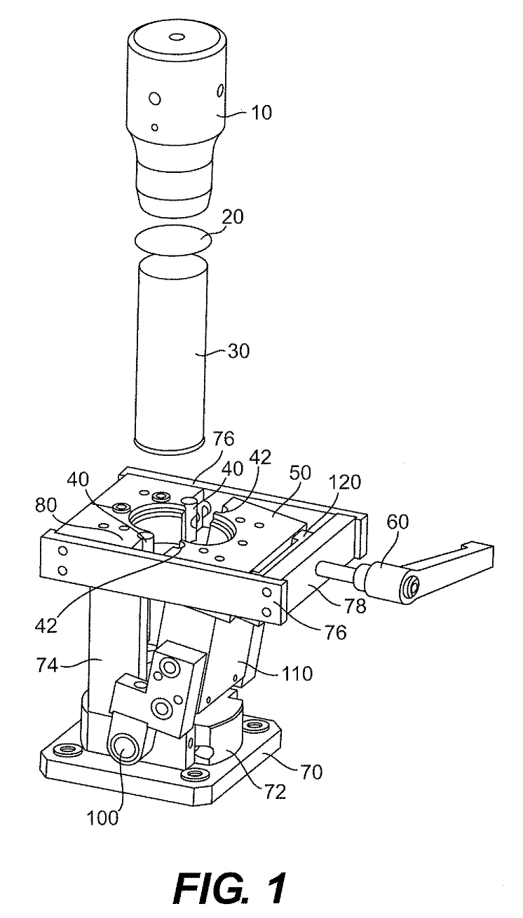

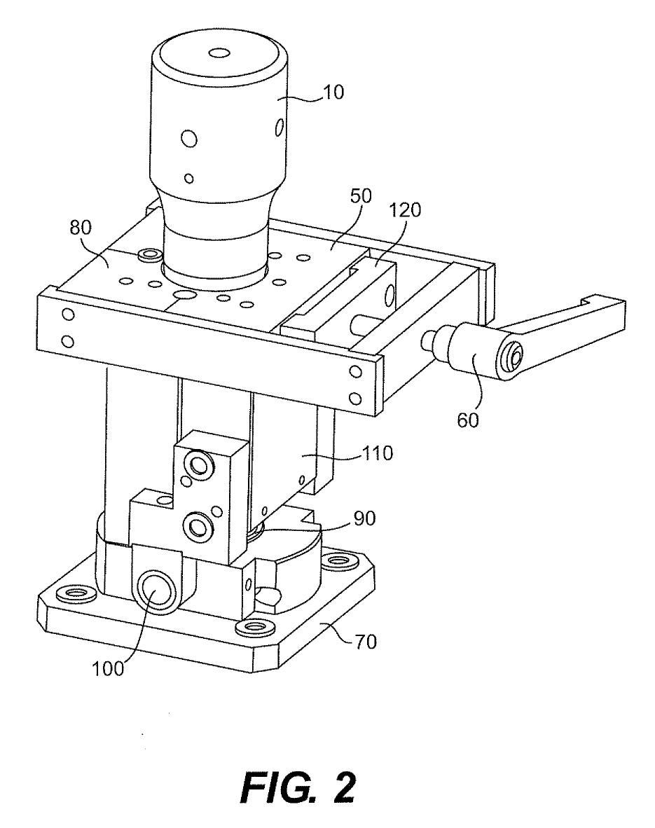

The implementation of the invention illustrated in FIGS. 1 and 2 shows a base plate 70 on which a landing 72 is placed. In landing 72 a floating pivoting device 110 is pivotable around an axis 100 that carries one of the anvil half-sections 50. A second anvil half-section 80 is fitted onto a carrier 74 in a stationary manner. The stationary anvil half-section 80 is fitted with two rounded projections 40 that are configured to fit into correspondingly rounded slots 42 provided in the anvil half-section 50 when the apparatus is closed. The projections 40 and the slots 42 together form a centering device that ensures that the anvil half-sections 50, 80 do not move when in the closed position. A frame made from two longitudinal braces 76 and a connecting cross brace 78 is fitted onto the anvil half-section 80 or onto the carrier and forms a mounting for a tommy screw 60, which acts on a clamping device 120 that is fitted onto anvil half-section 50. Schematically depicted above the anvil half-sections 50, 80, is an ultrasonic tool 10 configured to weld a bottom or a lid 20 onto a foil sleeve 30. To achieve this, the foil sleeve 30 is manually placed between the anvil half-sections 50, 80 in the open position, as illustrated in FIG. 1. The exact height position is precisely predetermined by a vertical height adjustment 90 shown in FIG. 2. Subsequently, the apparatus is closed by pivoting movable anvil half-section 50 toward anvil half-section 80 using floating pivoting device 110, and is held closed using clamping mechanism 120 and the tommy screw 60. Next, the bottom 20 is placed into the closed anvil half-sections 50, 80. In the anvil half-sections 50, 80 there are special centering devices and supply guides configured to pre-form the bottom 10 as it is placed in the foil sleeve. Finally, the ultrasonic tool 10 is lowered so the welding of the bottom 20 to the foil sleeve 30 can occur in the region between the anvil half-sections 50, 80.

After the welding process is finished, the ultrasonic tool 10 is raised and the tommy screw 60 is loosened so anvil half-section 50 can be pivoted away from anvil half-section 80.

A circular bag comprising the foil sleeve 30 fitted with the welded bottom 20 is subsequently removed. If a lid (not shown) is to be welded onto the circular bag, which is now closed at one end by bottom 20, the circular bag is turned 180° and again placed between the anvil half-sections 50, 80. Finally, the working operations described above are repeated until the lid is welded to the foil sleeve 30.

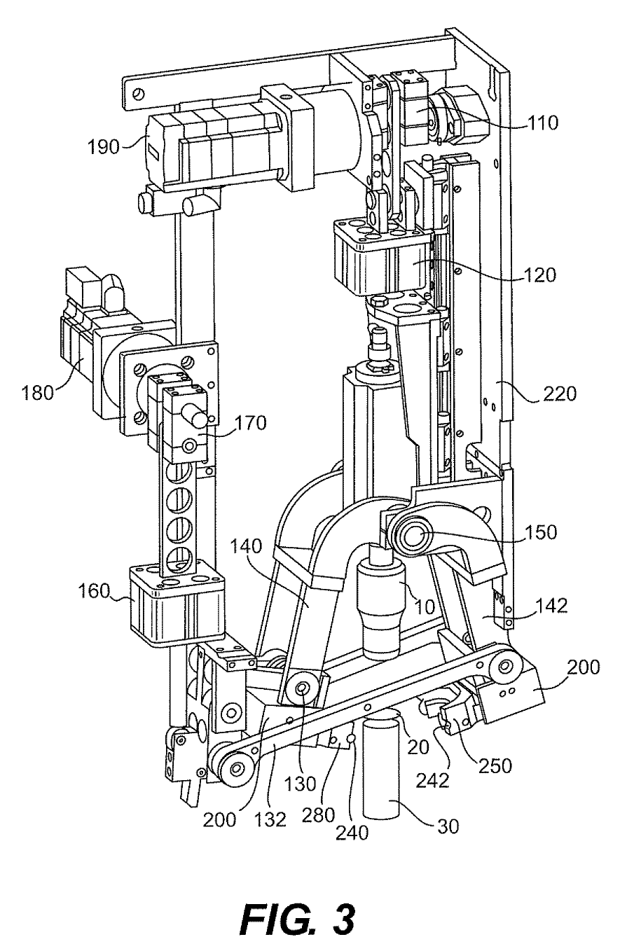

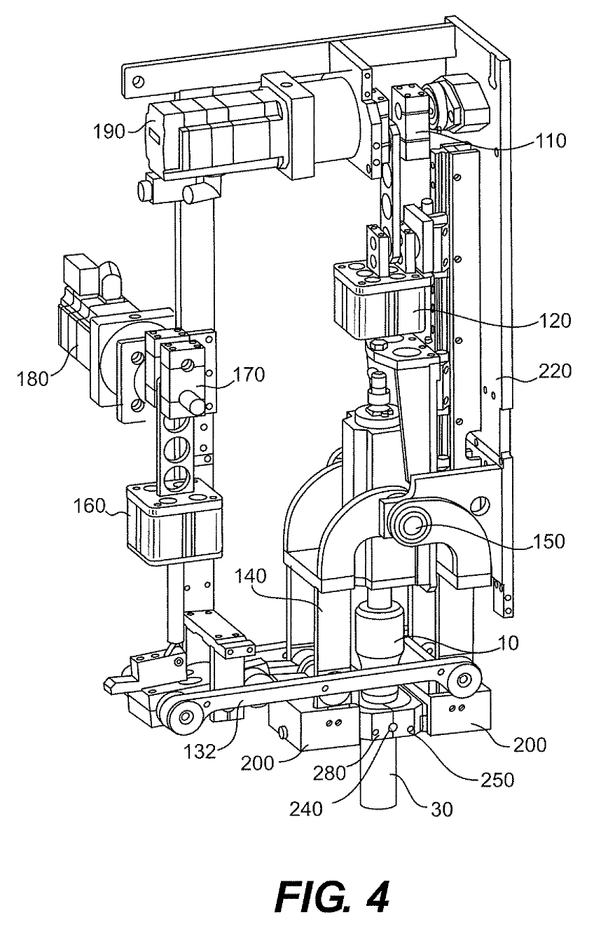

The above-described manufacturing apparatus can be used for manufacturing empty and filled circular bags. The manufacturing apparatus is particularly suitable for manual operation, although the steps described above could be automated. However, a second implementation of an apparatus for manufacturing a circular bag, which is described in connection with FIGS. 3 and 4, is particularly advantageous for the automated operation.

As illustrated in FIG. 3, two anvil half-sections 250, 280 are disposed within respective receivers 200 within which receivers the position of the respective anvil half-section can be exactly adjusted. The anvil half-sections 250, 280 can be pivoted from an open position to a closed position by means of lever chains 130, 132, 140, 142 around an axis 150. The pivoting movement occurs by means of a servo assembly 180 that activates a crank gear 170. Integrated into the crank gear 170 is a pneumatic spring 160 that permits reproduction of the clamp force adjustment. The crank gear 170 is articulated to the lever frame 130, 132, which, in turn, is articulated to the receivers 200 for the anvil half-sections 250, 280. Part of the lever frame 130, 132 is an eccentric adjuster 130 which is articulated to the crank gear 170, on the one hand, and to a sealing lever 140 for the anvil half-section 280, on the other hand. The eccentric adjuster ensures the symmetrical positioning of the anvil half-sections 250, 280 with respect to a foil sleeve 30.

The lever 132 is articulated to the crank gear 170 and to a sealing lever 142 for the anvil half-section 280, 250. Sideways extruding projections 240 and slots 242 are disposed within the walls of the respective anvil half-sections 280, 250, which touch in the closed position of the device. Projection 240 and slot 242 forms a centering device similar to the one described in connection with the description of the implementation in FIGS. 1 and 2. An ultrasound tool 10 is movable in a vertical direction by means of a servo assembly 190 and a crank gear 110 so that, in the closed position of the anvil half-sections 250, 280, ultrasound tool 110 is located just above said anvil half-sections 250, 280. Integrated into the crank gear 110 is a pneumatic spring 120 that facilitates reproduction of the sealing force adjustment.

As depicted in FIG. 4, the closed position of the anvil half-section 250, 280 is the dead point of the lever chain 130, 132, 140, 142, which permits very high clamping force by means of the crank gear 170 without the need for great drive power.

To seal a foil sleeve 30, the sleeve is inserted into sealing position by means of a transport system, which is not shown. By means of sorting and supply installation, which is not shown, a lid or bottom 20 is led into the sealing position between the sealing tool and anvil half-sections and is held in position in a gland (not shown). Subsequently, the ultrasound tool 10 is moved in a vertical direction by means of the servo assembly. In this manner, the lid or bottom 20 is pressed into the foil sleeve 30 by the gland in the anvil half-sections 250, 280. Subsequently, sleeve 30 is welded to the lid or bottom. As in the first implementation of an apparatus for manufacturing a circular bag, special centering devices and supply guides are led into the anvil half-sections 250, 280 which pre-form the lid or bottom 20 as it is supplied to the foil sleeve 30.

In the implementation of an apparatus for manufacturing a circular bag described with respect to FIGS. 3 and 4, separate devices are necessary for sealing the lid and the bottom, although it is possible to design a system that turns the foil sleeve 30 by 180°.

The characteristics of the invention revealed in the above specifications, in the drawings, as well as in the patent claims, could be significant for the realization of the invention individually as well as in any combination.

What is claimed is:

1. An apparatus for manufacturing a circular bag, comprising:
a first and a second anvil half-section, the first and second anvil half-sections being movable relative to each other from an open position to a closed position,
whereby the first and second anvil half-sections in the closed position define an interior space which at least corresponds to the exterior circumference of the circular bag; and
an ultrasonic sealing tool that is movable towards and away from the anvil half-sections.

2. The apparatus according to claim 1, further comprising a centering device configured to securely hold the first and second anvil half-sections in the closed position.

3. The apparatus according to claim 2, wherein the centering device comprises:
a projection disposed within or on a wall of the first anvil half-section; and
a corresponding slot disposed within or on a wall of the second anvil half-section,
wherein the projection and corresponding slot are configured to touch in the closed position.

4. The apparatus according to claim 1, wherein the first and second anvil half-sections are pivotable relative to each other.

5. The apparatus according to claim 1, wherein one of the first and second anvil half-sections is stationary with respect to a base configured to support the stationary anvil half-section.

6. The apparatus according to claim 5, wherein the other of the first and second anvil half-sections is a movable anvil half-section, wherein the movable anvil half-section is pivotable by means of a floating pivoting device along a rotation axis, wherein the rotation axis is disposed in a border area located between the first and second anvil half-sections when in the closed position.

7. The apparatus according to claim 5, wherein the movable anvil half-section is coupled to a clamp that is configured to engage a movable tommy screw, whereby the movable anvil half-section is held in place in the closed position by means of the tommy screw.

8. The apparatus according to claim 1, wherein the first and the second anvil half-sections are pivotable around a common axis.

9. The apparatus according to claim 8, wherein the first and the second anvil half-sections are movable by means of a lever chain that is configured to reach a dead point when the first and second anvil half-sections are in the closed position.

10. The apparatus according to claim 8, wherein one of the first and second anvil half-sections is articulated to an eccentric adjuster configured to ensure a symmetrical positioning of the first and second anvil half-sections to a foil sleeve placed between the first and second anvil half-sections.

11. A manufacturing apparatus for sealing a container, comprising:
a first anvil half-section;
a second anvil half-section movable with respect to the first anvil half-section from an open to a closed position, wherein, in the closed position the first and second anvil half-sections mutually define an interior region therebetween; and
an ultrasonic tool reversibly movable to a sealing position wherein an end portion of the ultrasonic tool is located in the interior region between the first and second anvil half-sections,
wherein, during sealing, the interior region is configured to contain the end portion of the ultrasonic tool and at least a portion of a sleeve of the container.

12. The manufacturing apparatus according to claim 11, further comprising a centering device configured to securely hold the first and second anvil half-sections in the closed position.

13. The manufacturing apparatus according to claim 12, wherein the centering device comprises:
a projection disposed on a wall of the first anvil half-section; and
a slot disposed on a wall of the second anvil half-section, wherein the projection and corresponding slot are configured to engage each other in the closed position.

14. The manufacturing apparatus according to claim 11, wherein the first and second anvil half-sections are pivotable relative to each other, and wherein the first and second anvil half-sections, when in the closed position, are configured to pre-form a lid to be sealed to the sleeve of the container.

15. The manufacturing apparatus according to claim 11, further comprising a base portion configured to support the first and second anvil half-sections, wherein the first anvil half-section is stationary with respect to the base and the second anvil half-section is movable with respect to the base.

16. The manufacturing apparatus according to claim 15, wherein the second anvil half-section is pivotable by means of a floating pivoting device along a rotation axis, wherein the rotation axis is disposed in a plane defined by a border area located between the first and second anvil half-sections when in the closed position.

17. The manufacturing apparatus according to claim 15, wherein the movable anvil half-section is coupled to a clamp that is configured to engage a movable screw, whereby the movable anvil half-section is held in place in the closed position by means of the movable screw.

18. The manufacturing apparatus according to claim 11, wherein the first and the second anvil half-sections are pivotable around a common axis.

19. The manufacturing apparatus according to claim 18, wherein the first and the second anvil half-sections are movable by means of a lever chain that is configured to reach a dead point when the first and second anvil half-sections are in the closed position.

20. The manufacturing apparatus according to claim 18, wherein one of the first and second anvil half-sections is articulated to an eccentric adjuster configured to ensure a symmetrical positioning of the first and second anvil half-sections to a container sleeve placed between the first and second anvil half-sections.
